(19) United States
(12) Patent Application Publication
(10) Pub. No.: US 2012/0192973 A1
(43) Pub. Date: Aug. 2, 2012

(54) Liquid transfer system

(76) Inventor: Harry Klepach, Sparks, NV (US)

(21) Appl. No.: 12/931,515

(22) Filed: Feb. 2, 2011

(51) Int. Cl. F15D 1/00

(52) U.S. Cl. 137/560

(57) ABSTRACT

A novel system for safely transferring liquids from containers such as plastic jugs that are sealed by frangible seals, to conventional drums of the character having coupler-operated extractor valves. In one form of the invention, a standard coupler mechanism has been modified in a manner to provide means for rupturing the frangible seal of the sealed container without adversely affecting the manner in which the coupler is used to operate the extractor valve that is carried by the drum to which the liquid is to be transferred. Additionally, a novel adapter member has been provided for interconnecting the sealed container to the coupler mechanism.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates generally to liquid transfer systems for transferring liquid from one container to another. More particularly, the liquid transfer system of the invention permits the safe and efficient transfer of liquid from a container sealed by a frangible seal to a drum type container of the character having a coupler operated extractor valve.

2. Description of Related Art Including Information Disclosed Under 37 CFR 1.97 AND 1.98

A number of different types of reusable systems for the storage, shipment and transport of liquid formulations have been suggested. One of the most advanced of such systems was developed by and is presently commercially available from Micro Matic, Inc. of Northridge, Calif.

The Micro Matic system is basically a two-part system which comprises a coupler operated extractor valve which is interconnectable with a conventional drum via existing threaded connections and a cooperating coupler which is operably coupled with the extractor valve to allow drum emptying through the use of a separate pumping system. The extractor valve apparatus which can either remain with the drum after emptying, or can be removed for drum processing, includes a valve body and a down tube connected to the valve body which extends to the bottom of the drum to permit the complete transfer of liquid from the drum.

Recently a need has developed to safely transfer liquids, including hazardous liquids, from containers such as plastic jugs that are sealed by frangible seals, to conventional drums of the character having coupler operated extractor valves. Problems related to such transfers include providing means for safely rupturing the frangible seal of the plastic jugs and means for operating the coupler operated extractor valve of the drum in a manner to permit the liquid to be safely transferred from the plastic jug into the reservoir of the drum. As will be better understood from the discussion which follows, after carefully analyzing these problems the present inventor solved them by providing an elegant but relatively simple closed system that includes a modified coupler which, upon normal operation, safely ruptures the frangible seal of the plastic jug and at the same time opens the coupler operated extractor valve on the drum so as to permit fluid to flow freely from the plastic jug into the reservoir of the drum. Without the present invention, in order to transfer liquids from a sealed plastic jug to the reservoir of a drum having a coupler-operated extractor valve, it would be necessary to remove the extractor valve from the drum, manually rupture the foil seal on the plastic jug and then pour the contents of the plastic jug into the drum. Such a procedure would be not only time-consuming but extremely dangerous if the liquid in the plastic jug was a hazardous liquid.

### BRIEF SUMMARY OF THE INVENTION

It is a primary object of the present invention to provide a system for safely transferring liquids from containers such as plastic jugs that are sealed by frangible seals, to conventional drums of the character having coupler operated extractor valves.

Another object of the invention is to provide a system of the aforementioned character in which a standard coupler mechanism has been modified in a manner to provide means for rupturing the frangible seals of the sealed containers without adversely affecting the manner in which the coupler is used to operate the extractor valve that is carried by the drum to which the liquid is to be transferred.

Another object of the invention is to provide a system as described in the preceding paragraphs in which the coupler has been modified to include a seal rupturing assembly that is carried within the housing of the coupler.

Another object of the invention is to provide a system of the class described in the preceding paragraph in which the seal rupturing assembly of the modified coupler is operated by the operation of actuating handle of the actuating assembly that is pivotally connected to the coupler body.

Another object of the invention is to provide a system of the character described in the preceding paragraphs that is of simple straight forward design and is quick and easy to use to safely accomplish the liquid transfer.

Another object of the invention is to provide a system of the character described that is inexpensive to produce and one that can be used with a minimum of training.

### BRIEF DESCRIPTION OF SEVERAL VIEWS OF THE DRAWINGS

FIG. 1 is a generally perspective, diagrammatic view showing one form of the liquid transfer system of the invention as it appears following interconnection of a plastic jug having a frangible seal with a conventional drum of the character having a coupler operated extractor valve.

FIG. 2 is a side elevational view, partly in cross-section that is similar to FIG. 1 and shows the liquid transfer system of the invention interconnecting a plastic jug having a frangible seal with a conventional drum of the character having a coupler-operated extractor valve.

FIG. 3 is a side elevational view partly in cross-section of one form of the liquid transfer system of the invention.

FIG. 4 is a view taken along lines 4-4 of FIG. 3.

FIG. 5 is a side elevational, partially cross-sectional view of a conventional coupler of the character that is used for operating the extractor valve of a conventional drum.

FIG. 6 is a side elevational partially cross-sectional view of a conventional coupler-operated extractor valve.

FIG. 7 is a side elevational cross-sectional view of one form of the adapter member of the invention for interconnecting a plastic jug having a frangible seal with the modified coupler assembly of the invention.

FIG. 8 is a generally diagrammatic view similar to FIG. 2, but further illustrating the location and configuration of the seal rupturing assembly of the modified coupler.

FIG. 9 is a generally diagrammatic view, similar to FIG. 8, illustrating the operation of the seal rupturing assembly to rupture the closure seal located in the threaded neck portion of the plastic jug.

### DETAILED DESCRIPTION OF THE INVENTION

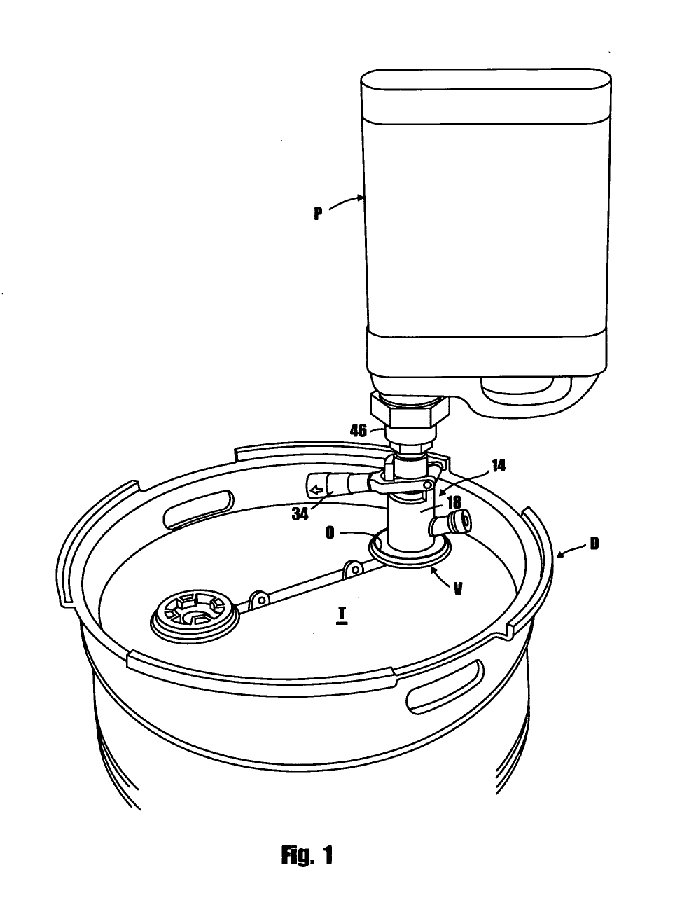

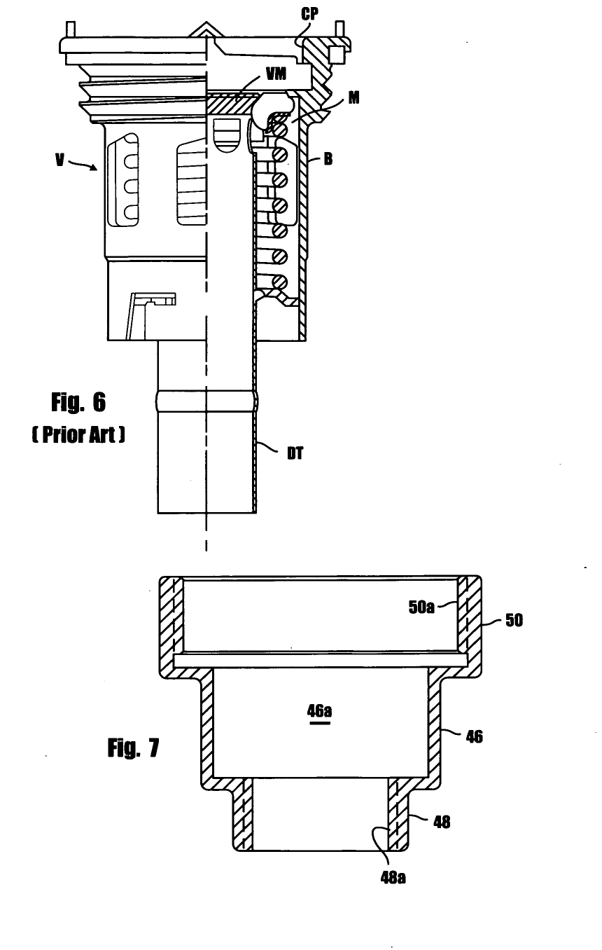

Referring to the drawings and particularly to FIG. 1, one form of the liquid transfer system of the invention is there shown and generally designated by the numeral 14. In FIG. 1, the liquid transfer system 14 is shown as it appears when interconnecting a conventional prior art plastic jug “P” having a frangible seal “S” with a conventional drum “D” of the character having a conventional coupler-operated extractor valve assembly which is generally designated in the drawing as “V”. Drum “D” is of a conventional type having a threaded opening “O” provided in the top wall “T” of the drum. In FIG. 1, the Micro Matic coupler-operated extractor valve assembly “V” is shown threadably interconnected with drum “D” with the valve body “B” thereof extending through opening “O” which is the access opening to the reservoir. Valve assembly “V” is further illustrated in FIG. 6 of the drawings and as there illustrated includes, in addition to valve body “B” which includes a connector port “CP”, a valve mechanism “M” and a down tube “DT” which is connected to the valve body and extends downwardly to a location proximate the bottom of the liquid containing drum “D”. Valve assembly “V” is of the character manufactured and sold by Micro Matic U.S.A., Inc. of Northridge, Calif. And the details of construction and operation of the valve assembly are fully described in technical publications available from Micro Matic U.S.A., Inc.

FIG. 5 of the drawings illustrates the configuration of a conventional Micro Matic coupler assembly “CA” that is of the character which, in a manner presently to be described, is modified to provide a critical part of the liquid transfer system 14 of the present invention. Coupler assembly “CA” is manufactured and sold by Micro Matic U.S.A., Inc. of Northridge, Calif. And the details of construction and operation of the coupler assembly “CA” are fully described in technical publications available from Micro Matic U.S.A., Inc.

In operation of the prior art Micro Matic system, the coupler assembly “CA” is interconnected with the valve assembly “V” via a conventional bayonet connection by inserting the lower portion of the coupler assembly into the connector port “CP” of the valve assembly and then rotating the assembly so that the lower portion of the coupler assembly is urged into sealable interconnection with the valve mechanism. This type of coupler-extractor valve interface is of a character well understood by those skilled in the art and is fully described in technical publications available from Micro Matic U.S.A., Inc. of Northridge, Calif.

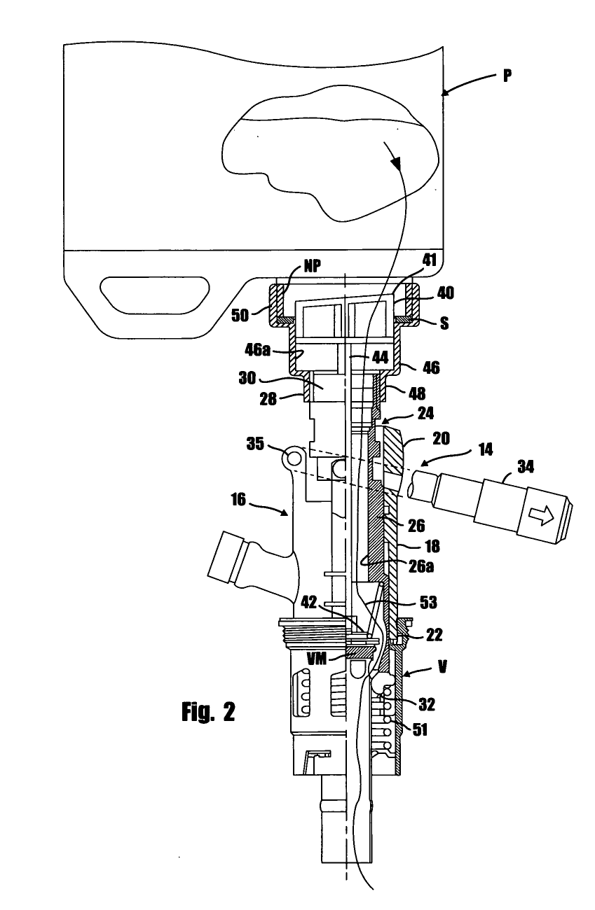

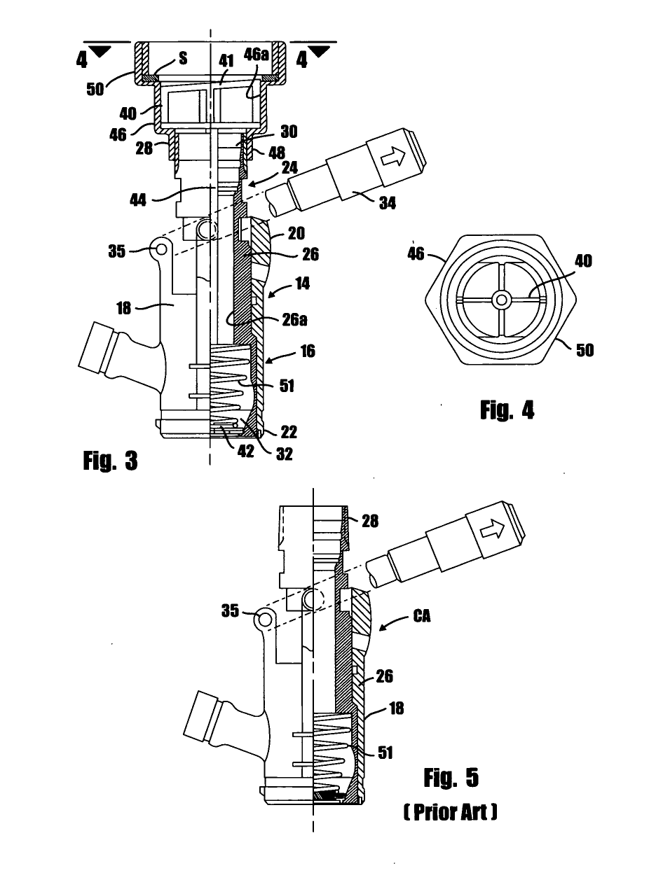

Turning now to FIGS. 2 and 3 of the drawings, the modified coupler assembly 16 of the present invention can be seen to comprise a coupler body 18 having an upper portion 20 and a lower portion 22. Disposed within the coupler body 18 is the novel actuating assembly 24 of the invention that includes an actuating member 26. In a manner presently to be described, actuating member 26 functions to move the valve member “VM” of the extractor valve assembly to an open position (see also FIG. 9). Actuating member 26 has an interior chamber 26a and an externally threaded neck portion 28 and is provided with an inlet port 30 and an outlet port 32. As seen in FIGS. 2 and 3, the actuating member is movable within the coupler body from the first at rest position shown in FIG. 3 to the second valve operating position shown in FIG. 2. Actuating assembly 24 further includes an actuating handle 34 that is pivotally connected to coupler body 18 at a pivot point 35 and is movable from the first upraised position shown in FIG. 3 to the second lowered position shown in FIG. 2.

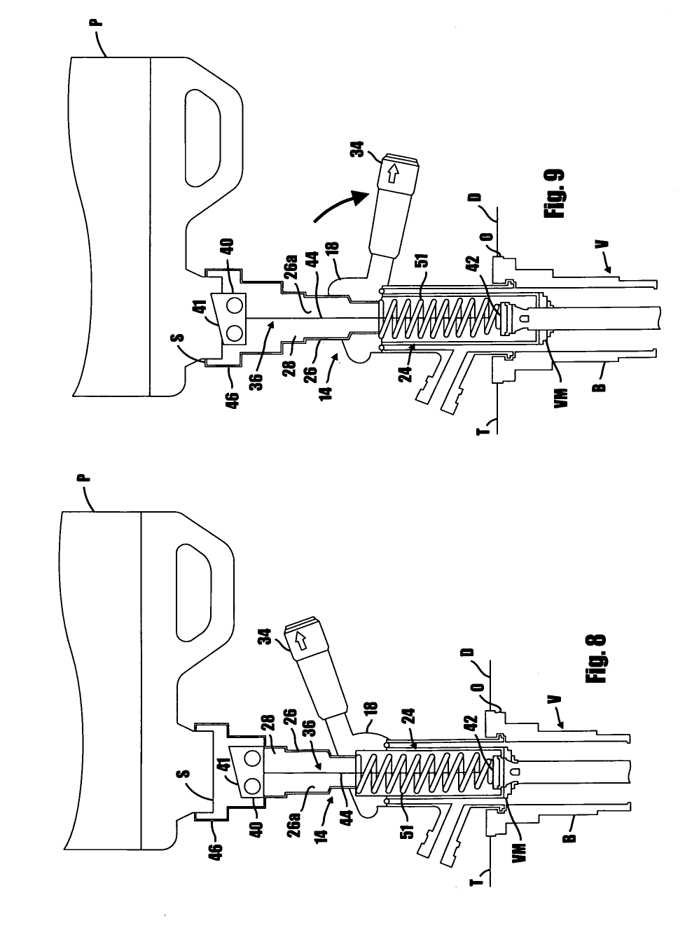

An important feature of the present invention is a cutter assembly 36 that is carried by the coupler assembly 14. This important assembly here includes a generally circular shaped punch cutter 40 for cutting the frangible seal, or frangible foil “S” of the plastic jug “P”. In a manner presently to be described, upon movement of actuating member 26 to its second position, the punch cutter 40 is movable from the first position shown in FIG. 3 to the second seal cutting position shown in FIGS. 2 and 9. In addition to punch cutter 40, which has a cutting. edge 41 for cutting the frangible seal of the first liquid container, cutter assembly 36 also includes a base member 42 and a punch rod 44 that is connected to and spans the punch cutter and the base member (see also FIGS. 8 and 9).

Forming another important part of the liquid transfer system of the present invention is a uniquely configured adapter member 46 (FIG. 6) that functions to threadably connect the first container “P” to the coupler body 18 of the coupler assembly 16. Adapter member 46, which has an interior chamber 46a, includes a first threaded portion 48 having interior threads 48a for threadable interconnection with the threaded neck portion 28 of the actuating member 26 and a second, larger diameter threaded portion 50 having interior threads 50a for threadable interconnection with the threaded neck portion “NP” of the first liquid container “P”.

In using the liquid transfer system of the invention, the first threaded portion 48 of the adapter member 46 is first threadably interconnected with the threaded neck portion of the actuating member 26. This done, the threaded neck portion of the first liquid container “P” is threadably connected to the second threaded portion 50 of the adapter member. Next, the assemblage thus formed is interconnected with the valve assembly “V” in the manner described in the preceding paragraphs and as illustrated in FIGS. 2, 8 and 9 of the drawings. A downward pressure exerted on the actuating handle 34 of the coupler assembly in the manner shown in FIGS. 2 and 9 of the drawings will cause the actuating member 26 of the coupler mechanism to move downwardly against the urging of a coil spring 51 that is carried within the adapter member in a manner to open the normally closed valve. As best seen in FIGS. 8 and 9 of the drawings, as the actuating member 26 moves downwardly, the punch cutter 40 of the cutter assembly 36 will move into the foil, or seal cutting position shown in FIG. 9 of the drawings, cleanly cutting the foil seal “S”. With the foil seal thusly cut, the fluid contained within the first container “P” will be permitted to safely and securely flow from the first container through the actuating member and into the down tube “DT” in the direction of the arrows 53 of FIG. 2 of the drawings. After the fluid has been safely transferred to the drum “D”, the first container “P” can be safely discarded. Once again, the operation of the conventional Micro Matic coupler assembly and the conventional Micro Matic coupler-operated extractor valve assembly “V” is well understood by those skilled in the art and is fully described in Micro Matic U.S.A., Inc. technical publications.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

1. In a liquid transfer system for transferring liquid from a first liquid container having a threaded neck portion including an outlet sealed by frangible seal to a second liquid container having a reservoir, an access opening to the reservoir and an extractor valve assembly connected to the access opening, which extractor valve assembly includes a valve member movable from a closed position blocking liquid flow through the extractor valve assembly to an open position permitting liquid flow there through, the improvement comprising:
(a) a coupler assembly removably interconnectable with the extractor valve assembly of said second liquid container, said coupler assembly comprising:
(i) a coupler body having an upper portion and a lower portion;
(ii) an actuating assembly carried by said coupler body for moving the valve member of the extractor valve assembly to an open position, said actuating assembly including an actuating member having threaded neck portion having an inlet port and an outlet port; and
(iii) a cutter assembly carried by said coupler body, said cutter assembly including a punch cutter movable from a first position to a second frangible seal cutting position upon movement of said valve member of the extractor valve assembly to an open position; and
(b) an adapter member for interconnecting the first container with said coupler body of said coupler assembly, said adapter member having an interior chamber; a first threaded portion for threadable interconnection with said threaded neck portion of said coupler assembly; and a second threaded portion for threadable interconnection with said threaded neck portion of said first liquid container.

2. In a liquid transfer system as defined in claim 1 in which said actuating assembly comprises:
(a) an actuating member having an interior chamber, said actuating member and being movable within said coupler body from a first position to a second position; and
(b) an actuating handle pivotally connected to said coupler body for movement from a first position to a second position to move said actuating member to said second position.

3. In a liquid transfer system as defined in claim 2 in which said cutter assembly of said coupler assembly is telescopically movable within said interior chamber of said actuating member.

4. In a liquid transfer system as defined in claim 2 in which said punch cutter of said cutter assembly includes a cutting edge for cutting the frangible seal of the first liquid container.

5. In a liquid transfer system as defined in claim 2 in which said punch cutter of said cutter assembly is disposed within said interior chamber of said adapter member.

6. In a liquid transfer system as defined in claim 2 in which said cutter assembly includes base member and a punch rod connected to and spanning said punch cutter and said base member.

7. In a liquid transfer system for transferring liquid from a first liquid container having a threaded neck portion including an outlet sealed by frangible seal to a second liquid container having a reservoir, an access opening to the reservoir and an extractor valve assembly connected to the access opening, which extractor valve assembly includes a valve member movable from a closed position blocking liquid flow through the extractor valve assembly to an open position permitting liquid flow there through the improvement comprising:
(a) a coupler assembly removably interconnectable with the extractor valve assembly of said second liquid container, said coupler assembly comprising:
(i) a coupler body having an inlet port and an outlet port;
(ii) an actuating assembly operably associated with said coupler body for moving the valve member of the extractor valve assembly to an open position, said actuating assembly comprising an actuating member movable within said coupler body from a first position to a second position, said actuating member having a threaded neck portion and an interior chamber, said actuating assembly further including an actuating handle pivotally connected to said coupler body for movement from a first position to a second position to move said actuating member to said second position;
(iii) a cutter assembly carried by said coupler assembly, said cutter assembly including a punch cutter movable from a first position to a second frangible seal cutting position upon movement of said actuating member to said second position;
(b) an adapter member for interconnecting the first container with said second liquid container, said adapter member having an interior chamber; a first threaded portion for threadable interconnection with said threaded neck portion of said actuating member; and a second threaded portion for threadable interconnection with the threaded neck portion of the first liquid container.

8. In a liquid transfer system as defined in claim 7 in which said punch cutter of said cutter assembly includes a cutting edge for cutting the frangible seal of the second liquid container.

9. In a liquid transfer system as defined in claim 7 in which said punch cutter of said cutter assembly is disposed within said interior chamber of said adapter member.

10. In a liquid transfer system as defined in claim 7 in which said cutter assembly includes base member and a punch rod connected to and spanning said punch cutter and said base member.

11. In a liquid transfer system for transferring liquid from a first liquid container having a threaded neck portion including an outlet sealed by frangible seal to a second liquid container having a reservoir, an access opening to the reservoir and an extractor valve assembly connected to the access opening, which extractor valve assembly includes a valve member movable from a closed position blocking liquid flow through the extractor valve assembly to an open position permitting liquid flow there through the improvement comprising:
(a) a coupler assembly removably interconnectable with the extractor valve assembly of said second liquid container, said coupler assembly comprising:
(i) a coupler body having an inlet port and an outlet port;
(ii) an actuating assembly operably associated with said coupler body for moving the valve member of the extractor valve assembly to an open position, said actuating assembly comprising an actuating member movable within said coupler body from a first position to a second position, said actuating member having a threaded neck portion and an interior chamber, said actuating assembly further including an actuating handle pivotally connected to said coupler body for movement from a first position to a second position to move said actuating member to said second position;
(iii) a cutter assembly carried by said coupler assembly, said cutter assembly including:
a. a punch cutter having a cutting edge for cutting the frangible seal of the second liquid container, said punch cutter being movable from a first position to a second frangible seal cutting position upon movement of said actuating member to said second position;
b. a base member; and
c. a punch rod connected to and spanning said punch cutter and said base member; and
(b) an adapter member for interconnecting the first container with said second liquid container, said adapter member having an interior chamber; a first threaded portion for threadable interconnection with said threaded neck portion of said coupler assembly; and a second threaded portion for threadable interconnection with the threaded neck portion of the first liquid container.

12. In a liquid transfer system as defined in claim 11 in which said punch cutter of said cutter assembly is disposed within said interior chamber of said adapter member.
